(19) United States
(12) Patent Application Publication
(10) Pub. No.: US 2009/0141241 A1
(43) Pub. Date: Jun. 4, 2009

(54) Animation apparatus

(76) Inventor: Ryan C. Buyssens, San Francisco, CA (US)

Correspondence Address: JOHN MCCULLOCH, 5291 COLONY DRIVE NORTH,, STE. 1, SAGINAW, MI, 48638, US

(21) Appl. No.: 12/313,985

(22) Filed: Nov. 26, 2008

Related U.S. Application Data
(60) Provisional application No. 61/005,130, filed on Dec. 3, 2007.

(51) Int. Cl. G03B 25/00

(52) U.S. Cl. 352/101

(57) ABSTRACT

Animation apparatus and methods wherein two- or three-dimensional individual animation items are carried by a support movable incrementally through an endless path composed of a plurality of segments or sections of uniform length. The number of animation items may be the same as, or more or less than, the number of incremental segments of such path. The frequency of movement and the speed of such movement during each segment, and the dwell period between successive segments, are such as to produce animation of the items via the persistence of vision phenomenon.

### CROSS REFERENCE TO RELATED APPLICATIONS

This application claims the benefit of the filing dates of U.S. Provisional Applications No. 60/873,673, filed Dec. 6, 2006 and No. 61/005,130 filed Dec. 3, 2007, respectively.

This invention relates to animation apparatus and a method for simulating motion by periodic movement of a sequence of inanimate objects or images.

### BACKGROUND OF THE INVENTION

One of the earliest animation devices is the hand-rotated Phenakistoscope (by J. Plateau, ca. 1832) employing a rotary disk with radial viewing slits arranged to create a shutter-like effect on a series of images applied to the reverse side of the disk. With the image side of the disk facing a mirror, the disk is rotated. By viewing through the slits the images reflected by the mirror the illusion of motion or animation is achieved. This device can be viewed by one person only and the animations are dark and difficult to see clearly due to the shutter-like effect of the slits.

An improvement of the Plateau design was the Zoetrope (by W. Homer, ca. 1834) which employs a manually rotatable cylindrical drum in which the top edge of the drum has vertical viewing slits for viewing sequential images carried by the interior of the drum. As the drum rotates, the slits create the same shutter-like effect animation. The animation can be viewed by more than one person, but the visible quality of the animation is little improved over the Plateau device.

Some years after the introduction of the Zoetrop design, E. Muybirdge substituted three-dimensional objects for the two-dimensional images proposed by Homer.

The Praxinoscope (proposed by E. Reynaud, ca. 1877) eliminated the need for viewing slits by employing a set of radially facing mirrors positioned in the center of either a hand rotated disk or cylinder to reflect the images toward the viewer. The animation could be viewed simultaneously by multiple persons and is bright. Certain distortions and restricted angles of view adversely affected this design.

All of the previously mentioned devices originally were hand rotated utilizing an uninterrupted, decaying rate of rotation. Later variations employed motors to obtain consistent rotational speed. An apparatus patented in 1999 by O. Pope utilizes a motor to rotate a disk at a continuous speed. Applied to the disk are three-dimensional objects that are illuminated by a pulsing strobe light source which creates an animation effect. Unobstructed open view is achieved, but with the disadvantage of having to use a strobe light source which can be difficult to see in certain lighting conditions and may adversely affect its viewers.

An object of the invention is to provide animation apparatus and methods for providing real time animation of inanimate objects and images without the necessity of viewing slits, shutters, mirrors, or specialized light sources.

### SUMMARY OF THE INVENTION

In the present invention the animation content is carried on the surface of a support that moves along an endless path in increments of uniform length. The content is sequential in nature and the effect of the intermittent movement creates the simulation of motion via the phenomenon of persistence of vision. The apparatus enables the animation content to be viewed without physical obstruction and without reliance on specialized lighting. Without limitations of viewing slits, and mirrors the content may be animated within three dimensions. Without the limitations of strobe or other special lighting, the content may be illuminated in any desired way. If the user desires, the content may be removed, rearranged, and replaced.

### THE DRAWINGS

FIG. 1 is a diagrammatic, isometric view of one embodiment of the invention;

FIG. 1a is a diagrammatic, isometric view of a modified embodiment;

FIG. 1b is a diagrammatic, isometric view of another embodiment;

FIG. 2 is a diagrammatic, isometric view of a further embodiment; and

FIG. 3 is a diagrammatic, isometric view of a further embodiment.

### DETAILED DESCRIPTION

In all of the disclosed embodiments of the invention the animation content comprises a sequence of inanimate three-dimensional objects or two-dimensional images arranged in spaced apart relation on a carrier or support for movement along an endless path. In the following description and claims the collection of dimensional objects and images shall be referred to as animation content, whereas a single object or image shall be referred to as an animation content item.

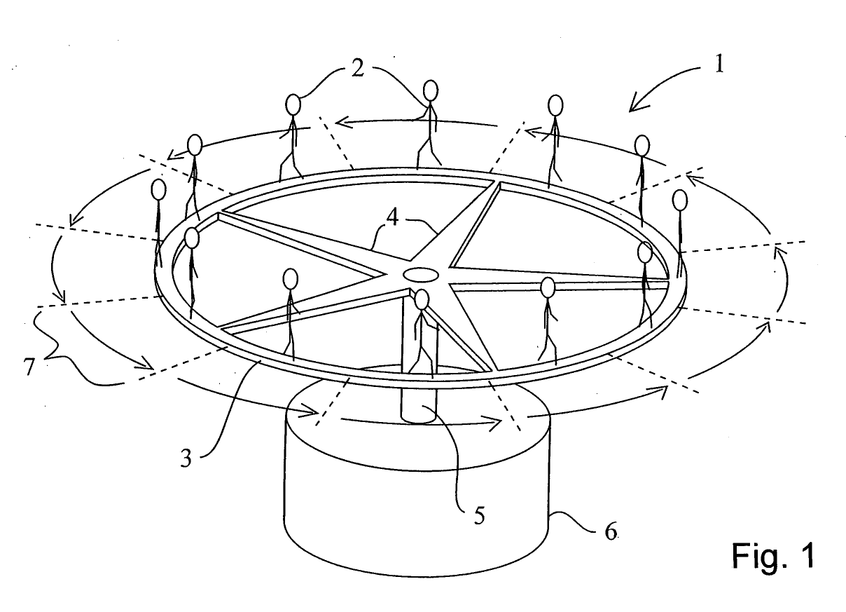

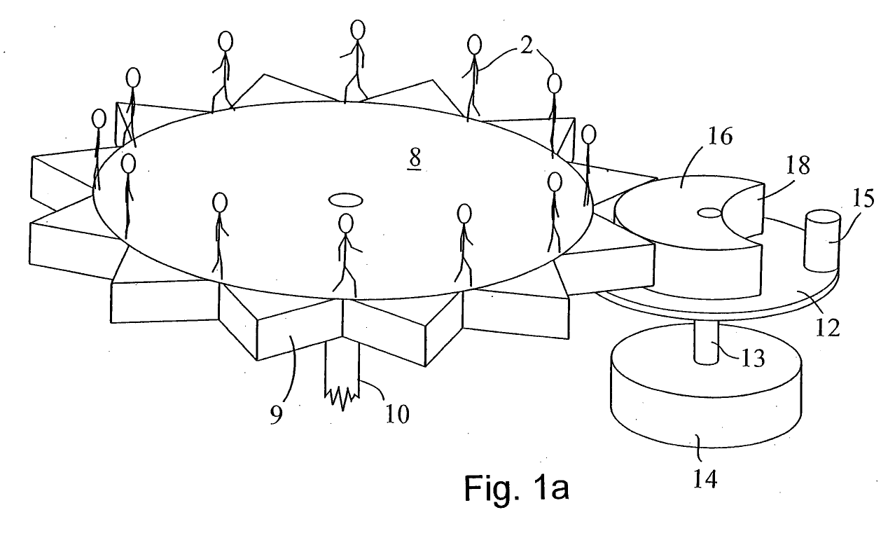

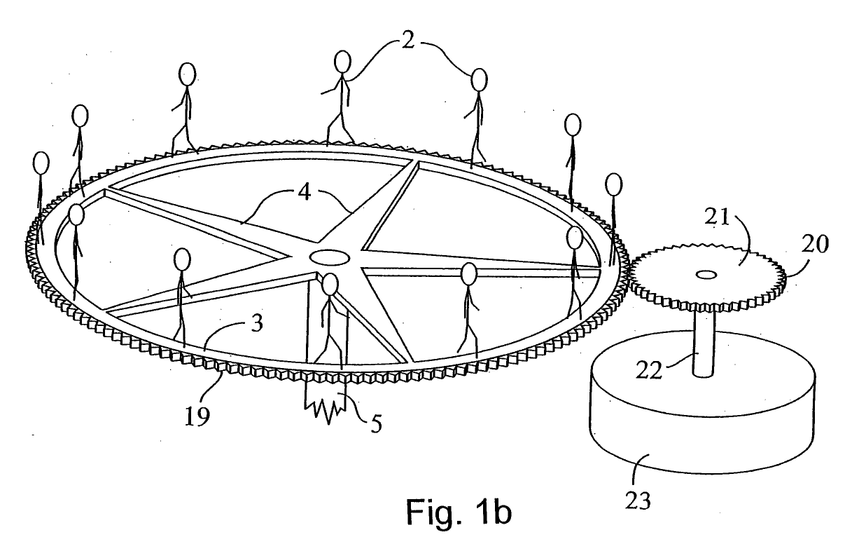

The apparatus shown in FIG. 1 comprises animation content 1 composed of a plurality of three-dimensional content items 2 arranged in uniformly spaced apart relation on a carrier ring 3 having spokes 4 connecting the ring to a rotatable, cylindrical spindle 5 driven by a known intermittently operable electric motor (not shown) located within a housing 6. The ring has a plurality of arcuate segments 7 and each content item 2 occupies the center of a segment 7. Each segment is of uniform dimensions. Rotation of the ring 3 forms an endless path of movement for the items 2 and each increment of movement corresponds to the circumferential length of each segment 7. After the ring traverses the length of each segment, the ring is stopped for a predetermined dwell period. The intermittent starting and stopping, or frequency, of the rotation of the ring is repetitive. The length of each successive dwell period is uniform and such as to enable the achievement of the phenomenon of persistence of vision.

Each illustrative content item 2 is a three-dimensional representation of a person having a head, a body, two arms, and two legs. Although each item is similar, the positions of the arms and legs of each figure are different for the purpose of providing an animation which presents the illusion during intermittent rotation of the ring that the person represented by the item is walking.

The embodiment shown in FIG. 1a comprises a ring 8 having peripheral, uniformly spaced, radially projecting teeth 9, the ring being coupled to a cylindrical spindle 10 journaled in a base (not shown). Adjacent the ring 8 is an intermittent geneva drive assembly 11 comprising a disk 12 coupled by a spindle 13 to a continuously rotating, known motor within a housing 14. Fixed to the periphery of the disk 12 is a drive pin 15 and a cam 16 having a majority of its peripheral surface 17 smooth and uninterrupted. However, the cam has a clearance 18 in a portion of the peripheral surface which confronts the pin 15.

In the operation of the embodiment shown in FIG. 1a the continuously operable motor is actuated to drive the disk 12 continuously so that the drive pin 15 periodically will enter the space between two adjacent teeth 9 of the ring 8, engage a tooth, index the ring in successive increments in an endless path, and then exit the space and disengage the drive pin 15. Once the drive pin disengages the tooth, the dwell surface 17 of the cam 16 will engage the surfaces of two adjacent teeth 9 and maintain the ring 8 in a fixed, nonrotating position until such time as the drive pin 15 is rotated through a distance sufficient to engage another tooth 9. During the engagement between a tooth 9 and the drive pin 15 to effect incremental indexing of the ring 8, the clearance 18 will avoid interference between the teeth 9 and the body of the cam 16.

The length and speed of incremental movement of the ring and the dwell period between successive rotary increments are such as to enable the persistence of vision phenomenon to be achieved so as to provide the illusion of animation to the animation content 1.

In the embodiment shown in FIG. 1b the support for each content item 2 is the same as that shown in FIG. 1. In FIG. 1b, however, the spindle 5 is not driven by a motor, but instead is mounted in a base (not shown) for free rotary movement. The ring 3 has peripheral teeth 19 which mesh with teeth 20 on the periphery of a pinion gear 21 supported on a spindle 22 and driven intermittently by a motor (not shown) in a housing 23. In all other respects the embodiment shown in FIG. 1b and its operation correspond to that of FIG. 1.

The embodiment shown in FIG. 2 has a cylinder 24 supported by spokes 25 on a cylindrical spindle 26 rotated intermittently by a known motor (not shown) within a housing 27. The cylinder 24 includes a preferably translucent support or sidewall 28 on which two-dimensional content items 2 are carried. Each content item 2 is an image and is spaced from the adjacent items by a uniform distance and such distance corresponds to the length of the uniform arc, as discussed in connection with the embodiment shown in FIG. 1. The operation and effect produced by the intermittent rotation of the cylinder 24 correspond to that produced by the intermittent rotation of the ring 3.

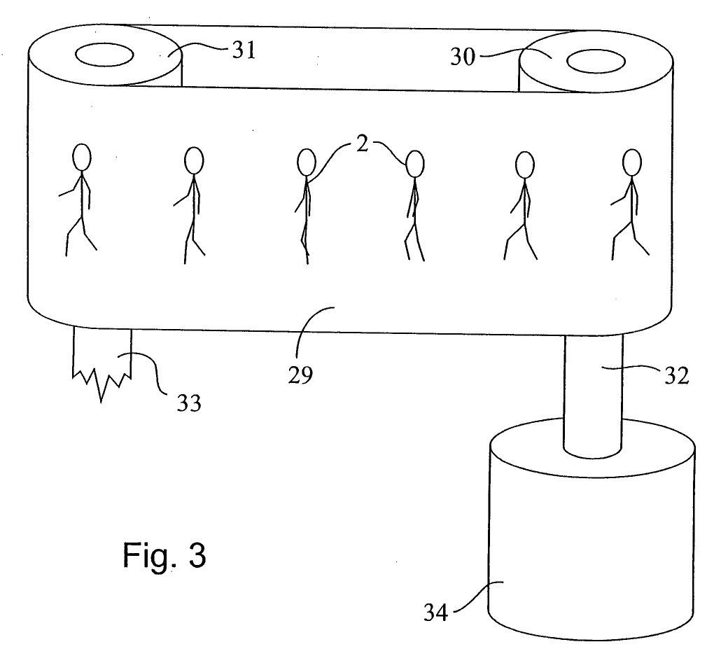

FIG. 3 illustrates a further embodiment wherein an endless, preferably translucent support or band 29 spans a pair of spaced apart turning drums 30 and 31 each of which has a supporting cylindrical spindle 32 and 33. The spindle 32 is coupled to and driven intermittently by a motor (not shown) in a housing 34. The spindle 33 is journaled at its lower end in a support (not shown) for free rotation. The band 29 carries a plurality of content items 2. The spacing between adjacent items 2 is uniform. Again, the spacing between the items, the incremental length of movement of the band, and the dwell period between indexing movements are such as to achieve the apparent animated movement of the content items via the persistence of vision phenomenon.

In each of the embodiments of FIGS. 2 and 3 the content items 2 may be backlighted by a source (not shown) of light arranged to illuminate the inner surface of the wall or band which carries the items 2.

In those instances in which the number of content items corresponds to the number of increments of movement in which the content carrier is indexed during a full or 360° cycle of movement, there will be no apparent drifting of movement of the content items 2 either to the left or to the right. However, an apparent drift can be produced by providing a number of content items 2 different from the number of indexing increments in a full cycle of movement. For example, if there are twenty increments of indexing movement and more than twenty equally spaced content items 2, the animation will be such that the items 2 will appear to drift in the direction of their path of movement by the carrier (the ring, cylinder, or band).

On the other hand, if there are twenty increments of indexing movement and fewer than twenty equally spaced apart content items 2, the animation will be such that they will appear to drift counter to the direction of movement of the carrier. Thus, in the embodiment shown in FIG. 1, rotation of the ring 3 when it carries more content items 2 than the number of incremental movements of the ring 3, will cause the item 2 to appear to be walking forward. If the ring carries fewer items 2 than the number of indexed movements of the ring 3, the rotation of the ring will cause the items 2 to appear to be walking backward.

The disclosed embodiments are representative of a presently preferred forms of the invention, but are intended to be illustrative rather than definitive thereof. The invention is defined in the claims.

I claim:

1. Automation apparatus comprising a movable support; a plurality of animation items carried by said support and together constituting animation content, said items being spaced apart from one another; and means for moving said support along an endless path in a plurality of segments, said automation items being sufficiently different from one another that the movement of said support produces animation of said content, the spacing between said items, the length of each segment of movement, and the speed of movement of said support being such as to produce the appearance of animation of said animation content.

2. The apparatus according to claim 1 wherein the number of said animation items carried by said support corresponds to the number of segments of said path.

3. The apparatus according to claim 1 wherein the number of said animation items is different from the number of segments of said path.

4. The apparatus according to claim 3 wherein the number of said animation items is less than the number of said segments.

5. The apparatus according to claim 3 wherein the number of said animation items is greater than the number of said segments.

6. The apparatus according to claim 1 wherein the space between adjacent automation items is uniform.

7. The apparatus according to claim 1 wherein each of said animation items is similar, but sufficiently different from adjacent ones of said items as to enable animation.

8. The apparatus according to claim 1 wherein said means for moving said support comprises an intermittently operable drive mechanism.

9. The apparatus according to claim 8 wherein said drive mechanism comprises an intermittently operable motor.

10. The apparatus according to claim 8 wherein the intermittently operable drive mechanism comprises a geneva wheel.

11. The apparatus according to claim 1 wherein each of said segments is of uniform length.

12. A method of animating animation content composed of a plurality of animation items carried by a support for movement along a path, said method comprising moving said support in successive increments along said path at such frequency that the phenomenon of persistence of vision produces the effect of animation of said animation content.

13. The method according to claim 12 wherein said path is endless.

14. The method according to claim 12 wherein each of said segments is uniform in length.

15. The method according to claim 12 wherein the number of said animation items is different from the number of segments of said path.

16. The method according to claim 15 wherein the number of said animation items is less than the number of said segments.

17. The method according to claim 15 wherein the number of said animation items is greater than the number of said segments.

18. The method according to claim 12 wherein the number of said animation items corresponds to the number of said segments.
